(19) United States
(12) Patent Application Publication
(10) Pub. No.: US 2013/0124805 A1
(43) Pub. Date: May 16, 2013

(54) APPARATUS AND METHOD FOR SERVICING LATENCY-SENSITIVE MEMORY REQUESTS

(71) Applicants: Todd M. Rafacz, Austin, TX (US); Kevin M. Lepak, Austin, TX (US); Ryan J. Hensley, Austin, TX (US)

(72) Inventors: Todd M. Rafacz, Austin, TX (US); Kevin M. Lepak, Austin, TX (US); Ryan J. Hensley, Austin, TX (US)

(73) Assignee: ADVANCED MICRO DEVICES, INC., Sunnyvale, CA (US)

(21) Appl. No.: 13/293,791

(22) Filed: Nov. 10, 2011

(51) Int. Cl. G06F 12/00

(52) U.S. Cl. 711/151; 711/E12.001

(57) ABSTRACT

A shared memory controller and method of operation are provided. The shared memory controller is configured for use with a plurality of processors such as a central processing unit or a graphics processing unit. The shared memory controller includes a command queue configured to hold a plurality of memory commands from the plurality of processors, each memory command having associated priority information. The shared memory controller includes boost logic configured to identify a latency sensitive memory command and update the priority information associated with the memory command to identify the memory command as latency sensitive. The boost logic may be configured to identify a latency sensitive processor command. The boost logic may be configured to track time duration between successive latency sensitive memory commands.

### FIELD OF INVENTION

This invention relates to apparatus and methods for memory management, and more specifically to an apparatus and method for servicing latency-sensitive memory requests.

### BACKGROUND

Central processing unit (CPU) workloads are primarily latency sensitive to memory requests. Graphics processing unit (GPU) workloads are primarily bandwidth sensitive and latency insensitive. In systems having shared memory, a scheduling policy that treats CPU and GPU workloads equally tends to be suboptimal for both the CPU and the GPU. A memory scheduler typically may be optimized for bandwidth or latency. Therefore, in systems having two clients with different needs, existing memory controller scheduling is often suboptimal.

### SUMMARY OF EMBODIMENTS

A shared memory controller and method of operation are provided. The shared memory controller is configured for use with a set of processors having different processing workloads (e.g., a CPU and a GPU). The shared memory controller includes a command queue configured to hold a plurality of memory commands from the processor and the graphics engine, each memory command having associated priority information. The shared memory controller includes boost logic configured to identify a latency sensitive memory command and update the priority information associated with the memory command to identify the memory command as latency sensitive. The shared memory controller includes a scheduler configured to pick memory commands from the command queue based on based on priority information.

The boost logic may be configured to identify a latency sensitive processor memory command. The latency sensitive processor memory command may be a read command. The boost logic may be configured to track time duration between successive latency sensitive memory commands. A boost counter may be configured to store a memory cycle count between latency sensitive memory commands.

The shared memory controller may include one or more processor memory interfaces configured to receive memory commands from the processors, and a memory device interface configured to transmit commands to a memory device.

The command queue may be configured to store memory commands having associated address and source information. The shared memory controller may include memory state circuitry configured to store state information associated with a memory device. The memory state circuitry may include a page table configured to store a plurality of entries, each entry being configured to store an active page associated with a memory bank The scheduler may be configured to a change memory state prior to picking a latency sensitive memory command from the command queue.

### BRIEF DESCRIPTION OF THE DRAWINGS

FIG. 1 is a block diagram of an accelerated processing unit (APU);

FIG. 2 is a block diagram of a memory scheduler with its associated logic circuitry;

FIG. 3 is a diagram of several command queue entries;

FIG. 4 is a diagram of several page table entries; and

FIG. 5 is a flowchart showing operation of the boost logic.

### DETAILED DESCRIPTION OF THE EMBODIMENTS

In order to provide more optimization in systems with central processing unit (CPU) workloads that are primarily latency sensitive to memory requests, and graphics processing unit (GPU) workloads that are primarily bandwidth sensitive and latency insensitive, a modified scheduling policy is disclosed. The present scheduler achieves more efficient overall performance than a scheduling policy that treats CPU and GPU workloads equally and also a policy that favors CPU workloads blindly over GPU workloads, such as assigning higher priority to CPU workloads over GPU workloads solely on the basis of workload origin. A balancing of CPU and GPU requests is disclosed. Although the terms GPU and CPU are used hereinafter, it should be noted that the terms may be used interchangeably with the term processor throughout. Additionally, the embodiments may utilize a plurality of GPUs, a plurality of CPUs or a mixture of GPUs and CPUs.

A scheduling policy may operate where GPU workloads are assigned a low priority and CPU workloads are assigned a higher priority (such as a medium priority level, for example). On the basis of this priority difference, the system may decide which requests to process. If priority fails to identify the workload to process, other factors, such as age of the request, may be included in the decision of which workload to process. For example, if there is a CPU request and a GPU request ready to be fulfilled; the CPU request may be processed first based on the CPU request being medium priority and the GPU request being low priority. If there are two CPU requests ready to be processed, the fact that the priority of both requests is the same fails to determine which request to process first. A determination of which request to process may be made based on the age of the request. That is, the oldest request of the highest represented priority level requests may be processed first.

In order to appreciate the decision by the scheduler, a discussion of some of the delays in memory access follows. First, there is a delay between the time when the memory is requested to be open and when the memory may be accessed. For example, if the memory is distributed over eight different banks, access to a row of memory is based upon opening the bank. An access request to the bank may be processed. After a delay, the bank may be open and access may be provided, thereby allowing the read or write command, directed to that bank referencing the appropriate row and location, to occur.

This delay in access may provide an opportunity for the scheduler to process requests in parallel. For example, if there are two requests to access different banks, the scheduler may request access in parallel. That is, the scheduler may request that the first bank be opened and, while waiting for the first bank to open, may request that the second bank be opened. The scheduler may then return to the request for the first bank, after the delay for the first bank, and provide the requested access, thereby allowing the read or write command to that first bank referencing the appropriate row and location to occur. The scheduler may then return to the request for the second bank, after the delay for the second bank, and provide the requested access, thereby allowing the read or write command to that second bank referencing the appropriate row and location to occur. Enabling the scheduler to work on both the first and second requests in parallel minimizes the overall total time for the two accesses to occur. This process may be extrapolated to three, four, and other myriads of multiple requests.

One operational difficulty that the scheduler needs to take into account in processing requests is a page conflict. A page conflict is where two requests map to the same bank but need to access different rows. In this situation, a scheduler may operate to prevent these requests from being performed in the same cycle, since access to different rows of a bank of memory may not be performed in parallel. In order to work around a page conflict, the scheduler may process a request based on the scheduling policy and may delay other requests to different rows of the same bank of memory until the processed request is complete.

Another delay in processing requests is associated with the electronics settling associated with the toggle between read and write requests. Switching from read to write, or write to read, requests may require a delay to allow the electronics to settle. As such, when the scheduler is processing read requests, the scheduler may continue to process subsequent read requests, while such read requests are in the queue, before waiting during the delay required in switching to write requests, for example. Further, if the last request is a write request, the scheduler may continue to send write requests, even lower priority write requests, in the face of a pending medium level read request in the queue since the read requests cannot be processed until the delay is instituted to allow for electrical settling.

Generally, a scheduler may allow an initiated request to be satisfied. That is, once the scheduler has begun to satisfy a request, this request may be allowed to be completed. This is the case, even if prior to completion, a higher priority request appears. The reason for allowing the started request to be completed, and in some cases forcing the higher priority request to be delayed, is that interrupting a request is extremely disruptive and time has been spent satisfying (at least partially), the first request. This time may be lost completely if the request is interrupted.

Disrupting an ongoing process is reserved only for the most critical of incoming requests. Further, breaking the rule with respect to switching from read to write or write to read and waiting for the electronics to settle may be occur for the most critical of requests. As described hereinafter, such requests are collectively termed boosted requests.

The present priority scheme may generally label GPU requests as low level requests and CPU requests as medium level requests as described. The present priority scheme may further augment the priority levels to include a high priority boost level that may be enabled to circumvent certain rules that enable processor flow. In particular, high priority may allow boost requests to disrupt ongoing processes and filling of requests, and may further allow boost requests to switch from read to write, or write to read, regardless of which prior read/write requests were being serviced. The requests that are assigned high priority may be deemed too latency sensitive to hold up processing and that the disruption of abruptly ending an ongoing process(es) and/or delay in switching to read/write, disruptions and delays that are normally avoided, may be acceptable in order to more quickly process the boosted request.

More specifically, certain embodiments may include boost logic used to guide the scheduler. Boost logic may test an incoming command to determine whether the command is a read command of a CPU. If the command is a read command of a CPU, boost logic may determine whether the command queue contains any commands of the CPU on the prior cycle and whether a boost counter has reached the predetermined threshold. If so, the command may be inserted into the command queue with elevated priority

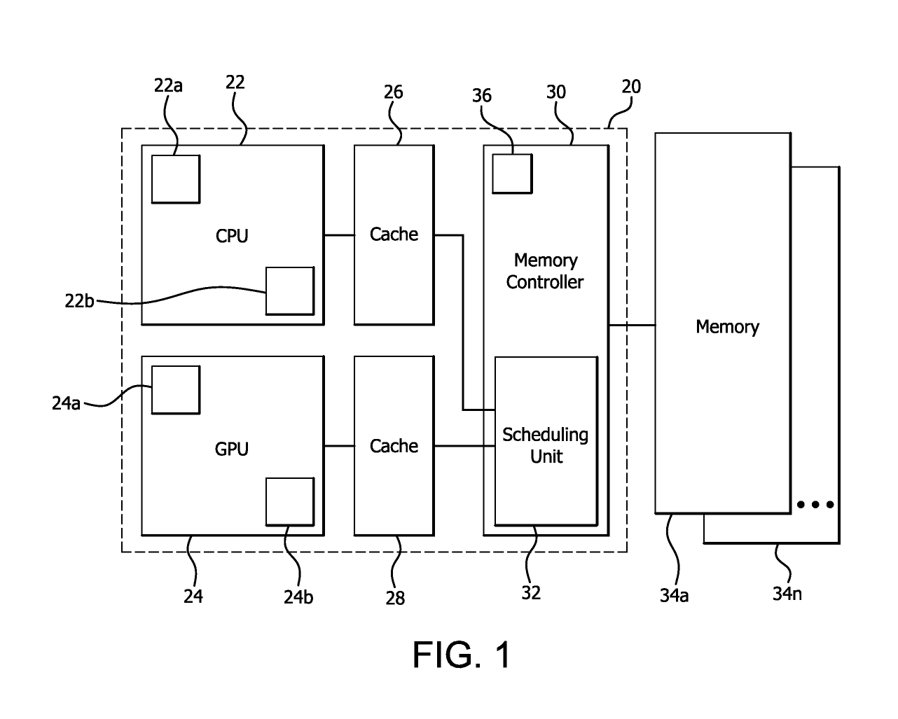

Referring now specifically to FIG. 1, which is a block diagram illustrating an accelerated processing unit (APU) 20 including a CPU 22 and a GPU 24. The CPU 22 and GPU 24 are coupled to a shared memory, shown generally as shared memory 34a-n. The CPU 22 and GPU 24 may have one or more associated caches shown generally as caches 26, 28, respectively. It should be understood that CPU 22 may include one or more cores, shown generally as cores 22a, 22b. Similarly, GPU 24 may have one or more pipelines, shown generally as pipelines 24a, 24b. The data paths from CPU 22 and the GPU 24 are coupled to memory controller 30. It should be understood the shared memory 34a-n may comprise a wide variety of memory devices, including, but not limited to, any form of random access memory devices, such as DRAM, SDRAM, DDR RAM and the like. Memory controller 30 may include multiple channels and may be coupled to shared memory 34a-n.

Memory controller 30 generally includes a scheduling unit 32 configured to manage memory access. Memory controller 30 may include a plurality of programmable locations 36 for storage of various parameters. It should be understood that such programmable locations 36 may be located within memory controller 30 or elsewhere.

In general, GPU 24 may tend to generate successive memory requests or “bursts” that are easily serviced; for example, successive write requests to specific areas of memory 34a-n. For this reason, traditional scheduler logic may service these requests ahead of requests generated by CPU 22. Scheduling unit 32 is configured to treat CPU 22 memory requests as latency sensitive when these requests are latency sensitive, and treat these requests as bandwidth sensitive when processor cores 22a, 22b primarily need bandwidth. Treating memory requests as latency sensitive has an impact on the bandwidth of GPU 24. It is therefore desirable to treat a memory request as latency sensitive only when necessary.

Scheduling unit 32 is configured to detect when CPU 22 memory requests are latency sensitive based on a variety of conditions. For example, when there is only one memory request from CPU 22 outstanding at the time of insertion into memory controller 30, a condition that provides a rough indication that the memory request is latency sensitive. In the opposite case, where CPU 22 is bandwidth bound, there are typically one or more memory requests from CPU 22 in memory controller 30 at the time a new memory request is inserted. These memory command queue conditions may be tracked per CPU 22 and/or may be tracked across all CPUs 22 to the extent multiple CPUs 22 are involved.

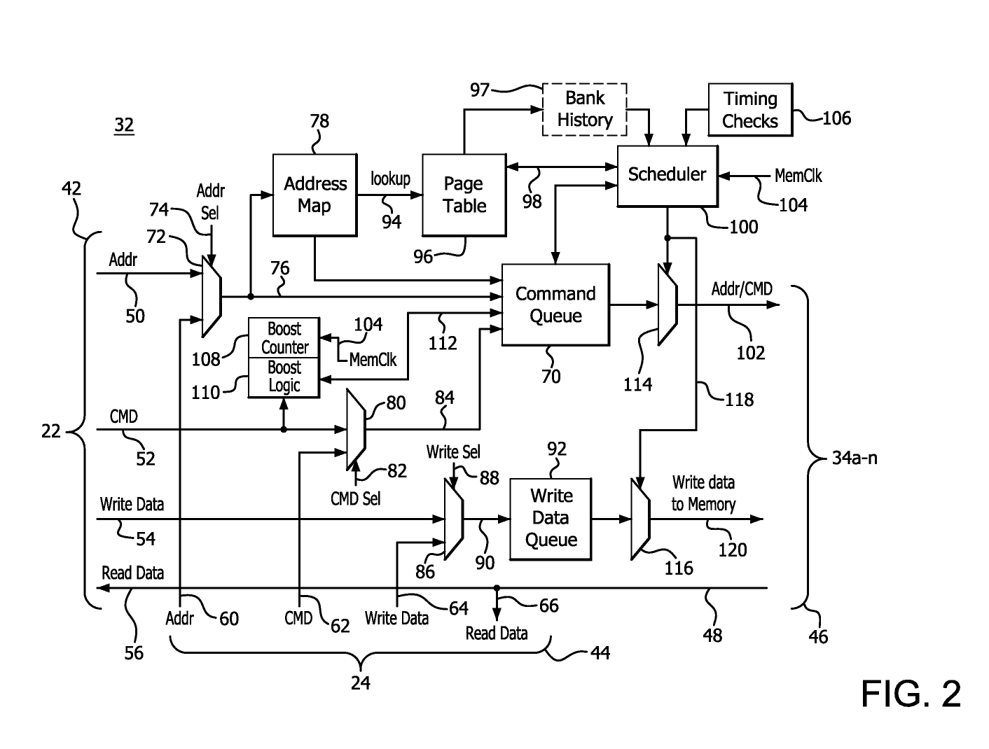

FIG. 2 is a block diagram of the logic circuitry of scheduling unit 32. Scheduling unit 32 includes a CPU memory interface 42, a GPU memory interface 44 and a memory device interface 46. CPU memory interface 42 includes an address line 50, a command line 52, a write data line 54 and a read data line 56. GPU memory interface 44 includes an address line 60, a command line 62, a write data line 64 and a read data line 66. Memory device interface 46 includes an address/command line 102 and a write data to memory interconnection 120. Data from CPU memory interface 42 and GPU memory interface 44 is coupled to logic circuitry as discussed below. Each memory request or command is placed in command queue 70. As will be described in further detail hereafter, certain processor (CPU or GPU) memory requests may be marked as latency sensitive (i.e. having a high priority). Memory controller 30 is configured to service such latency sensitive memory requests on an expedited basis, such as by interrupting a burst of existing requests, for example.

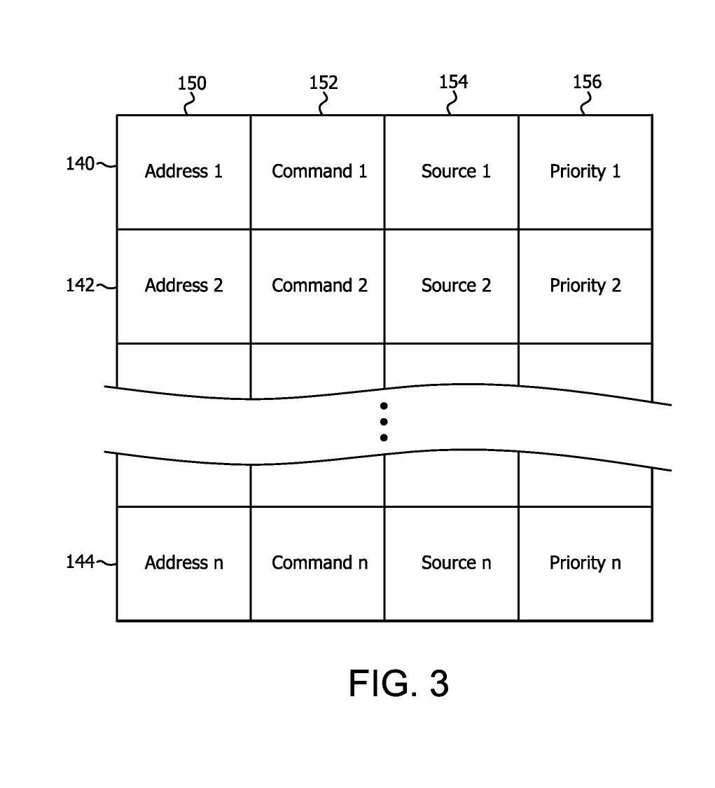

Referring now additionally to FIG. 3, there is shown a diagram of several command queue entries 140, 142, 144. Each entry includes an address 150, a command 152, source information 154 and priority information 156. Every command 152 has an associated address 150 as will be described in detail hereinafter with reference to FIG. 2. Source information 154 identifies the source of the address/command, such as CPU 22 and/or GPU 24, for example. Priority information 156 identifies whether the entry should be given priority over other entries. It should be understood that command queue entries 140, 142, 144 may include additional information such as size information, partial write masks and the like. Such information is omitted from FIG. 3 for purposes of clarity.

Referring again to FIG. 2, address data 50 from CPU 22 or address data 60 from GPU 24 is selected via address multiplexer 72 via address select input 74. Output 76 of address multiplexer 72 is then routed to the command queue 70 and address map 78. Command data 52 from CPU 22 or command data 62 from GPU 24 is selected via command multiplexer 80 via command select input 82. Output 84 of command multiplexer 80 is then routed to command queue 70. Write data 54 from CPU 22 or write data 64 from GPU 24 is selected via write data multiplexer 86 in response to write select input 88. Output 90 of write data multiplexer 86 is then routed to the write data queue 92. Data from the write data queue 92 is ultimately output 120 to memory 34a-n via multiplexer 116. Read data 56 to CPU 22 or read data 66 to GPU 24 is accessed via read data bus 48. It should be understood that various select signals are driven by conventional circuitry to allow address and command data to be stored in, and output by, command queue 70 and such circuitry is understood by those skilled in the art.

In general, memory command data 52, 62 and address data 50, 60 from CPU 22 and GPU 24, respectively, is written into command queue 70. The memory address associated with a given command is used as an input to memory state circuitry that may be stored in memory 34a-n. The memory state is then used to determine the proper timing for memory commands to be output 102 to memory 34a-n via multiplexer 114. In this example, the address data 50 is also routed to address map block 78 to decode the bank and page associated with a given memory request.

In order to access a typical dynamic random access memory, such as a DRAM device by way of example, various access procedures may be followed. For example, such devices are typically divided into a plurality of banks where each bank is associated with an address range. For each bank, a particular page (row) of the device is selected via an activate command. Typically, only one page is accessible at any given time.

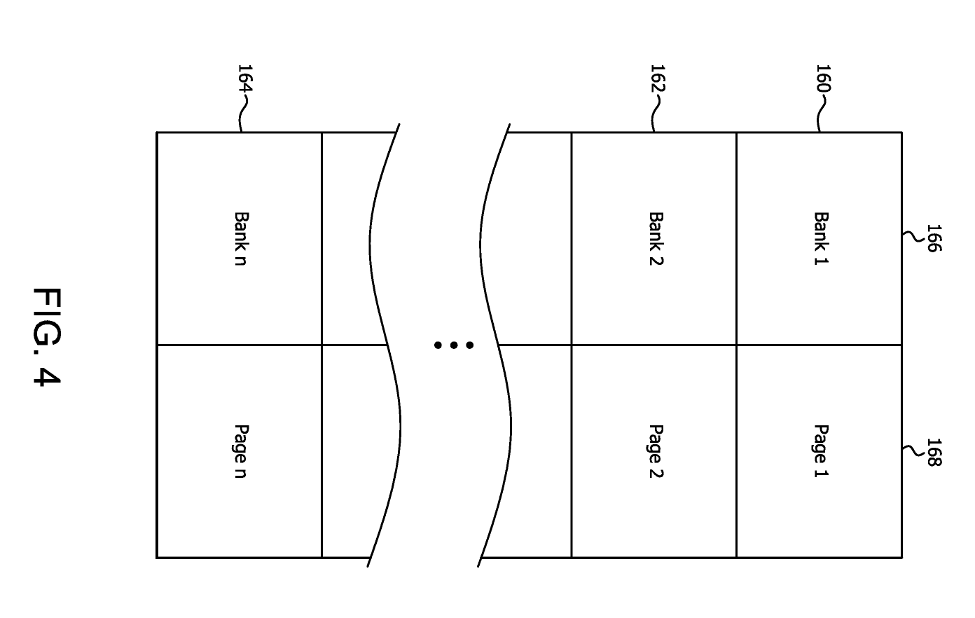

In order to access a memory location of interest that is associated with a specific page within a bank, the associated page in that bank must be open. Output 94 of address map 78 is coupled to page table 96. Page table 96 stores a plurality of entries 160, 162, 164 as shown in FIG. 4. Each entry contains the current state of memory 34a-n, such as active page 168 associated with a given bank 166. Assume for example a given memory has eight banks and the page is represented by a 15 bit number. In this case, page table 96 may be implemented as an eight entry table where each table entry stores 15 bits representing the open page. It should be understood that other structures may be used to implement a page table without departing from the scope of these embodiments.

Referring back to FIG. 2, scheduler 100 may access bank history 97 to determine whether or not to close the current page via a precharge command. For example, in cases where scheduler 100 is implemented with an open bank policy, bank history 97 may be used to store historical information used to predict the optimal bank state. The use of page history to determine whether to auto-precharge a page is optional in that it is typically implemented when there are no more commands left in the scheduler 100 to the same bank as the bank being read/written to at that time.

During each memory cycle, scheduler 100 checks the status of all command queue 70 entries to identify memory commands that are ready based on the memory state (such as whether the memory bank is opened), and various timing checks (such as the delays associated with opening memory banks and switching from read/write to write/read, for example). Scheduler 100 selects one or more of the commands from command queue 70 based on several criteria including, but not limited to, priority and/or age of the memory commands and ability to perform the commands in parallel, for example. Each selected command is then output to memory 34a-n along with any associated address information as shown by address/command output 102. This process is repeated during each memory cycle. In general, the memory cycle is tied to memory clock (MemClk) 104. It should be understood that several of the elements in FIG. 2 may be driven (directly or indirectly) by memory clock 104 or another similar device. The generation and use of a memory clock in connection with memory scheduler circuitry is within the scope of those skilled in the art.

The scheduler 100 is coupled to the page table 96 via a connection 98. This allows scheduler 100 to check the current state of memory 34a-n and select a command from command queue 70. When scheduler 100 selects a command that changes the page state, page table 96 is updated to reflect the new page state. Scheduler 100 is configured to perform various timing checks prior to issuing a command as guided by timing checks 106. For example, typical memory devices require a delay if a read command is followed by a write command or vice versa. Similarly, a delay is required between an activate or page open command and a subsequent memory access. Scheduler 100 is configured to issue commands on the appropriate memory cycle such that such timing delays are observed.

In general, write commands issued by CPU 22 are not latency sensitive. Accordingly, scheduling unit 32 may be configured to monitor read commands issued by CPU 22. Such commands are identified as either bandwidth sensitive or latency sensitive. Bandwidth sensitive commands may include, for example, the adding of two matrices. This addition is bandwidth sensitive because achieving an intermediate answer in the addition does not render the command complete, as there are still more additions that need to be performed. Latency sensitive commands may include, for example, a pointer chasing algorithm, which requests data and then waits for the data to be returned, and then may subsequently request more data. Bandwidth sensitive commands of CPU 22 may be inserted into command queue 70 without any special priority. Latency sensitive commands of CPU 22 may be inserted into command queue 70 with elevated priority information 156 so that these latency sensitive commands are picked by scheduler 100 as a result of elevated priority information 156. Such elevated priority commands of CPU 22 are subsequently selected more quickly by scheduler 100 and sent to memory 34. This mechanism may send a plurality (i.e a “burst”) of commands from GPU 24 and minimize the latency associated with such elevated priority commands of CPU 22.

A boost counter 108 and associated boost logic 110 are coupled to the command queue 70 through interconnection 112. Boost counter 108 stores a running count of memory cycles, such as based on memory clock 104, for example. When a new CPU 22 command is received on command line 52, boost logic 110 determines the priority associated with this command before the command is inserted into command queue 70. If a read command is received from CPU 22, and command queue 70 did not contain any commands from CPU 22 on the prior cycle, the boost count is checked. If the boost counter 108 exceeds a predetermined threshold, the read command of CPU 22 is inserted into command queue 70 with elevated priority, such as including one or more bits indicating that the memory command is latency sensitive, for example. Boost counter 108 is reset each time a command from CPU 22 is elevated or “boosted.” The predetermined threshold may be stored in a programmable location, such as one of programmable locations 36 shown in FIG. 1.

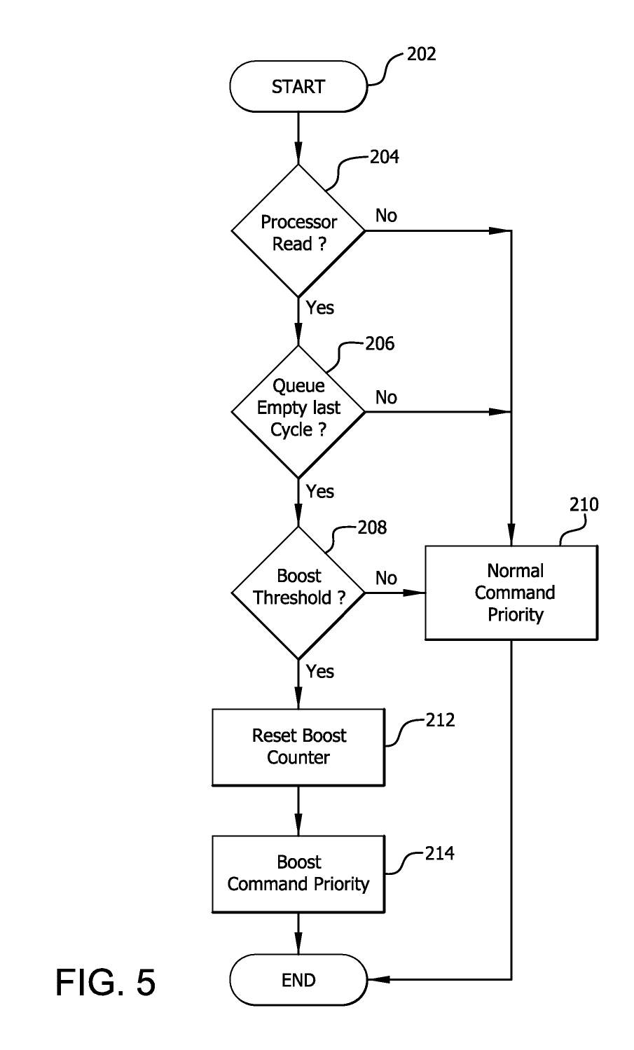

FIG. 5 is a flow diagram illustrating operation of boost logic 110. It should be understood that the flow diagrams contained herein are illustrative only and that other entry and exit points, time out functions, error checking functions and the like (not shown) would be implemented in a typical system. Any beginning and ending blocks are intended to indicate logical beginning and ending points for a given subsystem that may be integrated into a larger device and used as needed. The order of the blocks may be varied without departing from the scope of this disclosure. Implementation of these aspects is readily apparent and within the grasp of those skilled in the art based on the disclosure herein.

Boost logic 110 processing begins at step 202. Boost logic 110 tests an incoming command to determine whether it is a read command of CPU 22 at step 204. If the command at issue is not a read command of CPU 22, the command is inserted into command queue 70 with normal priority at step 210. If the command at issue is a read command of CPU 22, boost logic 110 determines whether command queue 70 contains any commands of CPU 22 on the prior cycle at step 206. If the command queue did not contain a command of CPU 22 on the prior cycle, the command is inserted into command queue 70 with normal priority. If the command queue did contain a command of CPU 22 on the prior cycle, boost logic 110 determines whether boost counter 108 has reached the predetermined threshold at step 208. If boost counter 108 does not exceed the predetermined threshold, the command is inserted into command queue 70 with normal priority. If boost counter 108 exceeds the predetermined threshold, boost counter 108 is reset at step 212 and the command is then inserted into the command queue with elevated priority at step 214.

In operation, scheduler 100 is configured to select a command from command queue 70 during each memory cycle using an arbitration process. Each command in command queue 70 may generally fall into one of three categories: page hit, page miss or page conflict. A page hit generally occurs when the desired memory page is open for a given memory command. In this case, the command is ready to be output to memory 34a-n. In a given memory cycle there may be several commands in command queue 70 that are ready. Under these conditions, scheduler 100 is configured to select the oldest command. However, if one of the ready commands has a boosted status, this command may be picked over other commands. In effect, this prevents commands from GPU 24 from arbitrating during this memory cycle.

A page miss generally occurs when the desired page is closed. Scheduler 100 may then send an activate command to open the desired page before the memory command may be ready. A page conflict generally occurs when memory 34a-n is open to the wrong page. In this case, scheduler 100 must send a precharge command to close the page and an activate command to open the desired page before the memory command may be ready.

If a command in command queue 70 has a boosted status and there is a page miss or page conflict condition, scheduler 100 may take steps to pick these commands as soon as possible. For example, scheduler 100 may first send a precharge and/or activate command. Scheduler 100 may then wait until the boosted command passes all timing checks, that is until the activate command is completed, for example. During this period, scheduler 100 may pick other commands and send those to memory 34a-n.

Although the CPU commands have been described as having an elevated priority, it should be noted that GPU commands or certain CPU or GPU commands may be assigned elevated or different priorities without departing from the present disclosure.

It should be understood that many variations are possible based on the disclosure herein. Although features and elements are described above in particular combinations, each feature or element may be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the present invention.

What is claimed is:

1. A shared memory controller configured for use with a set of processors, each processor having a processing workload, the shared memory controller comprising:
a command queue configured to hold a plurality of memory commands from the set of processors, each memory command having associated priority information;
boost logic configured to identify a latency sensitive memory command and update the priority information associated with the memory command; and
a scheduler configured to select memory commands from the command queue based on based on the priority information.

2. The shared memory controller of claim 1, wherein the latency sensitive processor memory command is a read command.

3. The shared memory controller of claim 1, wherein the boost logic is configured to track time duration between successive latency sensitive memory commands.

4. The shared memory controller of claim 3, further comprising a boost counter configured to store a memory cycle count between latency sensitive memory commands.

5. The shared memory controller of claim 1, wherein the set of processors includes a central processing unit (CPU) and a graphics processing unit (GPU).

6. The shared memory controller of claim 5, further comprising a processor memory interface configured to receive memory commands from the CPU, a graphics engine memory interface configured to receive memory commands from the GPU and a memory device interface configured to transmit commands to a memory device.

7. The shared memory controller of claim 1, wherein the command queue is configured to store memory commands having associated address and source information.

8. The shared memory controller of claim 1, further comprising memory state circuitry configured to store state information associated with a memory device.

9. The shared memory controller of claim 8 wherein the memory state circuitry comprises a page table configured to store a plurality of entries, each entry being configured to store an active page associated with a memory bank.

10. The shared memory controller of claim 8 wherein the scheduler is configured to a change memory state prior to picking a latency sensitive memory command from the command queue.

11. A method of controlling a shared memory used with a plurality of processors, each processor for issuing a plurality of memory commands, the method comprising:
storing a plurality of memory commands from the plurality of processors, each memory command having associated priority information;
identifying a latency sensitive memory command and updating the priority information associated with the memory command to identify the memory command as latency sensitive; and
selecting memory commands from the command queue based on based on the priority information.

12. The method of claim 11, wherein the latency sensitive memory command is a central processing unit memory command.

13. The method of claim 12, wherein the latency sensitive processor memory command is a read command.

14. The method of claim 11, further comprising tracking time duration between successive latency sensitive memory commands.

15. The method of claim 11, further comprising storing a memory cycle count between latency sensitive memory commands.

16. The method of claim 11, wherein the memory commands have an associated address and source information.

17. The method of claim 11, further storing state information associated with a memory device.

18. The method of claim 11, further comprising storing a plurality of page table entries, each page table entry being configured to store an active page associated with a memory bank.

19. The method of claim 18, further comprising changing a memory state prior to picking a latency sensitive memory command from the command queue.

20. A computer readable media including hardware design code stored thereon, and when processed generates mask works for a shared memory controller configured for use with a plurality of processors, the method comprising:
storing a plurality of memory commands from the plurality of processors, each memory command having associated priority information;
identifying a latency sensitive memory command and updating the priority information associated with the memory command to identify the memory command as latency sensitive; and
selecting memory commands from the command queue based on based on the priority information.
